(19) United States
(12) Patent Application Publication
(10) Pub. No.: US 2016/0004870 A1
(43) Pub. Date: Jan. 7, 2016

(54) Personal Security Agent

(71) Applicant: AT&T Intellectual Property I, L.P., Atlanta, GA (US)

(72) Inventors: Andrea Forte, Brooklyn, NY (US); Edward G. Amoroso, Andover, NJ (US); Gustavo de los Reyes, Fair Haven, NJ (US); Mikhail Istomin, Brooklyn, NY (US)

(73) Assignee: AT&T INTELLECTUAL PROPERTY I, L.P., Atlanta, GA (US)

(21) Appl. No.: 14/320,774

(22) Filed: Jul. 1, 2014

(51) Int. Cl. G06F 21/60; G06N 99/00; H04L 12/911

(52) U.S. Cl. CPC G06F 21/60; H04L 47/70; G06N 99/005

(57) ABSTRACT

Concepts and technologies disclosed herein are directed to a personal security agent. According to one aspect disclosed herein, a compute resource includes a processor that can execute the personal security agent to perform operations. The compute resource can receive data from a data source. The compute resource can receive a job request to provide security for an entity. The job request can include a job requirement. The compute resource can analyze the job requirement and the data to determine an action. The compute resource can provide instructions for executing the action to a controller domain. The controller domain can execute the action in at least partial fulfillment of the job requirement.

### BACKGROUND

Digital footprints encompass data collected about people based upon their activities online. With the emergence of fast mobile wireless data connections, the availability of WI-FI hotspots, the rapid adoption of social media services, and the prevalent use of online services for financial transaction, among other online activity, people are now exposing more data about themselves, often unknowingly. As a result, digital footprints are becoming larger and the data encompassed in digital footprints is becoming more easily accessible, thus exposing people to targeted attacks and other security breaches.

### SUMMARY

Concepts and technologies disclosed herein are directed to a personal security agent. According to one aspect disclosed herein, a compute resource includes a processor that can execute the personal security agent to perform operations. The compute resource can receive data from a data source. The compute resource can receive a job request to provide security for an entity. The job request can include a job requirement. The compute resource can analyze the job requirement and the data to determine an action. The compute resource can provide instructions for executing the action to a controller domain. The controller domain can execute the action in at least partial fulfillment of the job requirement.

In some embodiments, the compute resource also can receive an effect of the action from the controller domain. The compute resource can execute a learning algorithm to utilize the effect to improve security for the entity. The compute resource also can receive a learning input. The compute resource can execute the learning algorithm to additionally or alternatively utilize the learning input to improve security for the entity.

In some embodiments, the compute resource can receive a query from the controller domain. The query can be in regards to performance of the action. The compute resource can respond to the query with information for use by the controller domain in executing the action in at least partial fulfillment of the job requirement.

In some embodiments, the entity is a user. In these embodiments, the controller domain can include a personal security controller that can execute the action if the action pertains to a personal domain of the user. The controller domain alternatively or additionally can include a work security controller that can execute the action if the action pertains to a work domain of the user.

In some embodiments, the action includes a verification of a mobile payment request. In some other embodiments, the action includes a verification of maliciousness of a message. In some other embodiments, the action includes an authentication for virtual private network access.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a diagram illustrating an operating environment for a personal security agent and a plurality of security controllers operating in various security controller planes to provide tailored security for an entity that utilizes one or more equipment types operating in an equipment plane, according to an illustrative embodiment.

FIG. 2 is a diagram illustrating an example implementation of personal security agent for an entity that uses equipment operating within a personal domain and a work domain, according to another illustrative embodiment

FIG. 3 is a diagram illustrating aspects of a personal security agent, according to an illustrative embodiment.

FIG. 4 is a flow diagram illustrating aspects of a method for providing personalized security for an entity via a personal security agent, according to an illustrative embodiment.

FIG. 5 is a diagram illustrating aspects of a security controller under the control of a personal security agent, according to an illustrative embodiment.

FIG. 6 is a flow diagram illustrating aspects of a method for providing personalized security for an entity via a security controller, according to an illustrative embodiment.

FIG. 7 is a diagram illustrating aspects of a financial transaction scenario in which a personal security agent is utilized to provide personalized security for an entity during a financial transaction, according to an illustrative embodiment.

FIG. 8 is a diagram illustrating aspects of a malicious short message service (“SMS”) message scenario in which a personal security agent is utilized to provide personalized security for an entity to prevent malicious SMS messages from being delivered to a device associated with the entity, according to an illustrative embodiment.

FIG. 9 is a diagram illustrating aspects of a virtual private network (“VPN”) access scenario in which a personal security agent is utilized to provide personalized security for an entity to allow the entity VPN access to a server computer, according to an illustrative embodiment.

FIG. 10 is a block diagram illustrating an example mobile device, according to some illustrative embodiments.

FIG. 11 is a block diagram illustrating an example computer system, according to some illustrative embodiments.

FIG. 12 schematically illustrates a network, according to an illustrative embodiment.

### DETAILED DESCRIPTION

Concepts and technologies disclosed herein are directed to personal security agents. Personal security agents can provide security tailored to an entity to address security vulnerabilities for the entity and the infrastructure and services the entity utilizes. In this manner, attacks that target a specific entity can be effectively defended or prevented altogether. Personal security agents can utilize one or more data sources to determine actions to be taken to defend against or prevent attacks and other security vulnerabilities. Personal security agents can learn about the entity to be protected, security vulnerabilities of the security, and past attacks, among other information about the entity, to mitigate or eliminate the effects of attacks and to reduce or stop future attacks.

While the subject matter described herein may be presented in the general context of program modules that execute in conjunction with the execution of an operating system and application programs on a computer system, computing device, mobile device, and/or other computing resource, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

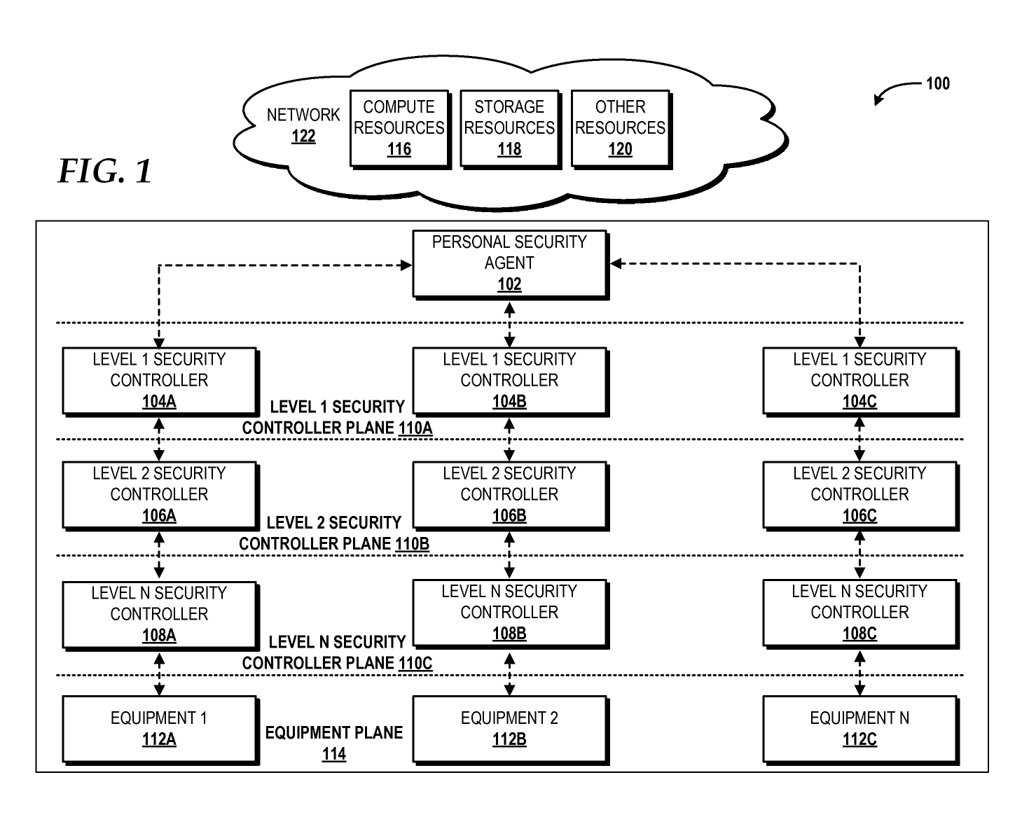

Referring now to FIG. 1, a diagram illustrating an operating environment 100 for a personal security agent 102 and a plurality of security controllers 104A-104C, 106A-106C, 108A-108C operating in various security controller planes 110A-110C to provide tailored security for an entity that utilizes equipment 112A-112C operating in an equipment plane 114 will be described, according to an illustrative embodiment. The personal security agent 102 can provide security tailored to the security requirements of a specific entity and one or more domains that the entity uses. In this manner, targeted attacks and other security breaches can be prevented and/or the effects thereof can be mitigated. The entity protected by the personal security agent 102 may be an individual, a group of individuals, a business or portion thereof, a communications network or component thereof, a cloud computing environment or a component thereof, an infrastructure or a component thereof, or any other entity for which tailored security is desired.

The entity embodied as an individual may be, for example, a user of a service, device, computing system, cloud computing environment, infrastructure, point-of-sale (“POS”) system, vehicle, smart home, network, multiples thereof, combinations thereof, or the like. The entity embodied as a group of individuals may be, for example, a family, a group of friends, a group of employees, a group of acquaintances, or any other grouping of individuals. The entity embodied as a business may be any business for which tailored security is desired.

The entity embodied as a communications network may be or may include, for example, one or more wireless local area networks (“WLANs”), one or more wireless wide area networks (“WWANS”), one or more wireless metropolitan area networks (“WMANs”), one or more campus area networks (“CANs”), and/or one or more packet data networks such as the Internet or a portion thereof. The communications network may use any wireless communications technology or combination of wireless communications technologies, some examples of which include, but are not limited to, WI-FI, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other Institute of Electrical and Electronics Engineers (“IEEE”) 802.XX technologies, and the like. The communications network embodied as a WWAN may operate using various channel access methods (which may or may not be used by the aforementioned technologies), including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Single-Carrier FDMA (“SC-FDMA”), Space Division Multiple Access (“SDMA”), and the like. Data may be exchanged via the communications network using cellular data technologies such as, but not limited to, General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. It should be understood that the communications network may additionally include infrastructure that operates on wired communications technologies, including, but not limited to, optical fiber, coaxial cable, twisted pair cable, and the like to transfer data between various systems operating on or in communication with the network. The entity alternatively may be embodied as a component of any of the aforementioned network types.

The personal security agent 102 can provide security tailored to the security requirements of a specific entity at least in part by leveraging the interconnectivity among equipment, such as the equipment 112A-112C (“equipment 112”) operating within the equipment plane 114 that forms, at least in part, an “Internet of Things.” For example, the equipment 112 can include, but is not limited to, smart homes and/or components thereof, smart watches, smart televisions, smart appliances, smart glasses, smart jewelry, smart accessories, other smart devices, set-top boxes, video game consoles, handheld video game systems, mobile telecommunications devices (e.g., smartphones and tablets with WWAN connectivity), computing systems (e.g., desktop computers, laptop computers, notebook computers, ultrabook computers, servers, network attached storage systems, and the like), vehicles and/or components thereof, key access devices (e.g., key fobs), security equipment (e.g., motion sensors, cameras, light sensors, and alarm systems), databases, point-of-sale (“POS”) systems, fitness devices (e.g., calorie trackers, heart rate monitors, running watches, and pedometers), combinations thereof, and the like.

The personal security agent 102 can provide security tailored to the security requirements of a specific entity at least in part by leveraging learning algorithms configured to utilize feedback from one or more of the plurality of security controllers 104A-104C, 106A-106C, 108A-108C operating in the security controller planes 110A-110C to adapt to the security needs of the entity. The personal security agent 102 can enable transparent security monitoring to prevent attacks directed towards the protected entity. While the personal security agent 102 may aim to minimize the possibility of attacks, the personal security agent 102 also can react to attacks to eliminate or at least mitigate the effects of attacks.

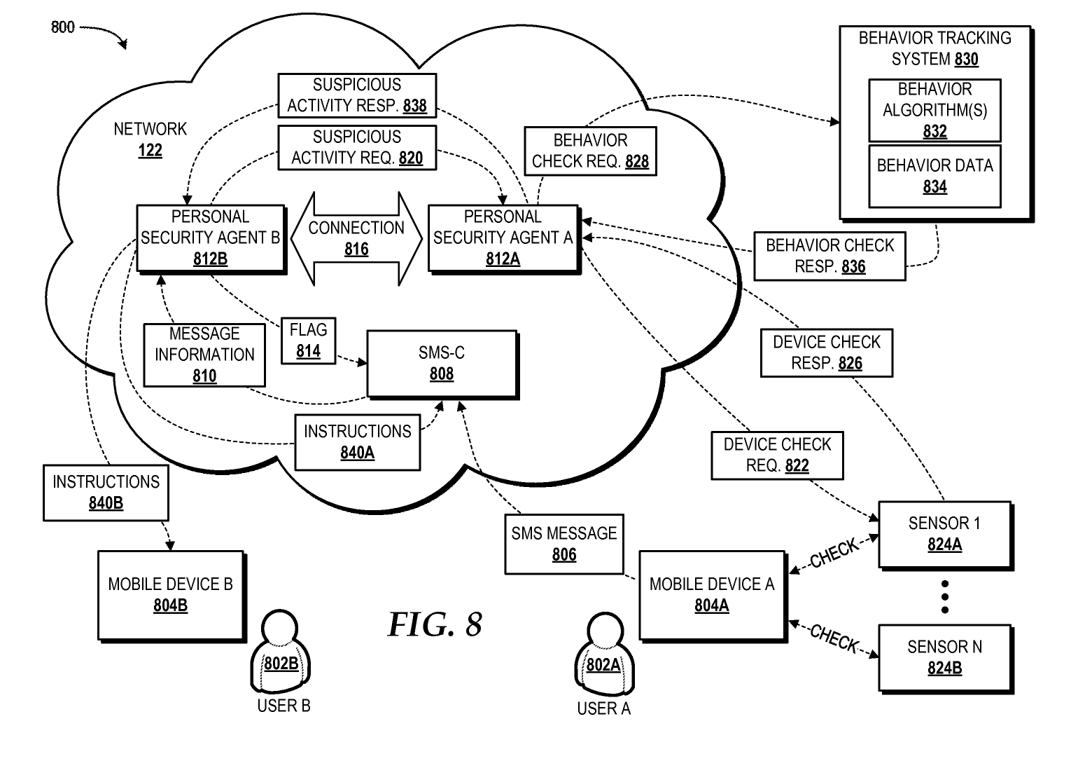

The personal security agent 102 can communicate with other agents (an example of which is best shown in FIG. 8), individuals, and/or controllers, such as one or more the plurality of security controllers 104A-104C, 106A-106C, 108A-108C in the illustrated embodiment, to perform various operations described herein. The personal security agent 102 can receive event data from one or more of the plurality of security controllers 104A-104C, 106A-106C, 108A-108C regarding events that involve systems, devices, networks, infrastructure, and/or the like that operate in one or more domains under the protection of the personal security agent 102. A domain can be, for example, a home of a user, a workplace of a user, a vehicle of a user, a network, or any other environment that includes one or more devices, computing systems, or other equipment that an entity utilizes and for which the entity desires tailored security.

The personal security agent 102 can determine one or more actions to be performed to provide tailored security to an entity. The personal security agent 102 can provide instructions for performing the action(s) to one or more level 1 security controllers 104A-104C (“level 1 security controller(s) 104”) operating within the level 1 security controller plane 110A. The level 1 security controller(s) 104 can receive the instructions from the personal security agent 102. The level 1 security controller(s) 104 also can determine, based at least in part upon the instructions, how to perform one or more actions, such as, for example, how to perform one or more security operations to protect the entity, and can perform the action(s). An action can include an action performed by the level 1 security controller(s) 104 and/or by one or more devices, computing systems, and/or the like within a domain under at least partial control of the level 1 security controller(s) 104. An action alternatively can include instructing one or more of the level 2 security controllers 106A-106C (“level 2 security controller(s) 106”) operating within the level 2 security controller plane 110B to perform one or more actions.

The level 2 security controller(s) 106 can receive instructions from the level 1 security controller(s) 104. The level 2 security controller(s) 106 also can determine, based at least in part upon the instructions, how to perform one or more actions, such as, for example, how to perform one or more security operations to protect the entity, and can perform the action(s). An action can include an action performed by the level 2 security controller(s) 106 and/or by one or more devices, computing systems, and/or the like within a domain under at least partial control of the level 2 security controller(s) 106. An action alternatively can include instructing one or more of the level N security controllers 108A-108C (“level N security controller(s) 108”) operating within the level N security controller plane 110C to perform one or more actions.

The level N security controller(s) 108 can receive instructions from the level 2 security controller(s) 106. The level N security controller(s) 108 can determine how to perform one or more actions, such as, for example, how to perform one or more security operations to protect the entity, and can perform the action(s). An action can include an action performed by the level N security controller(s) 108 and/or by one or more devices, computing systems, and/or the like operating within a domain under at least partial control of the level N security controller(s) 108. An action alternatively can include instructing the equipment 112 or a portion thereof operating within the equipment plane 114 to perform one or more actions.

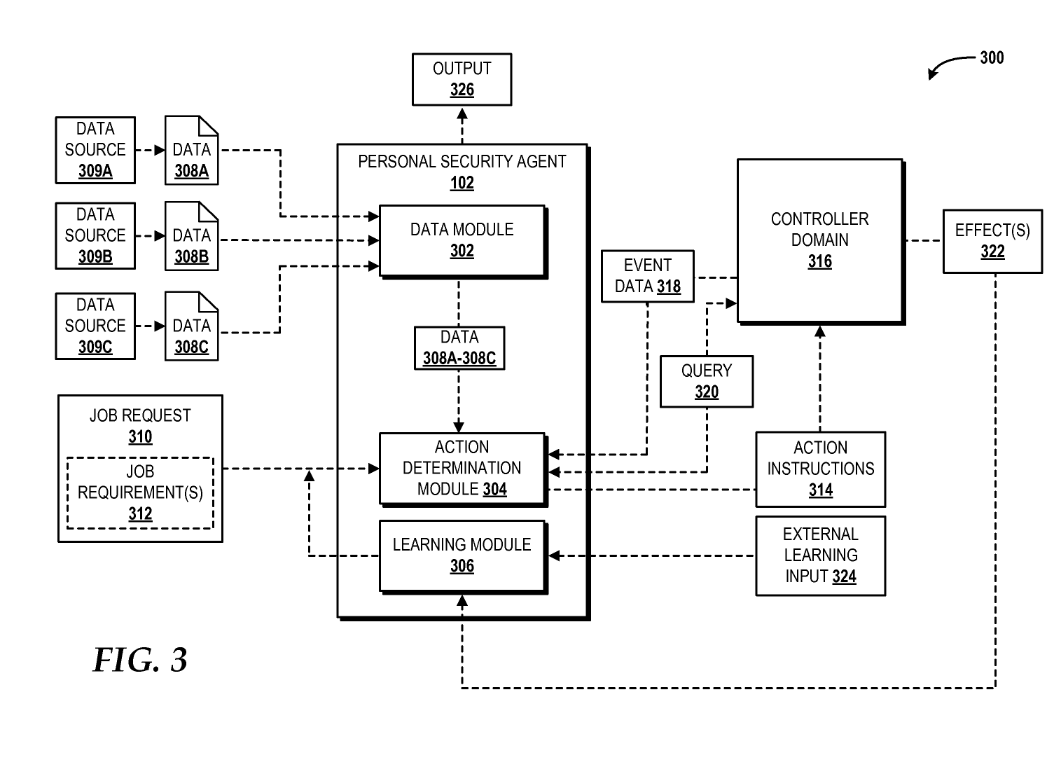

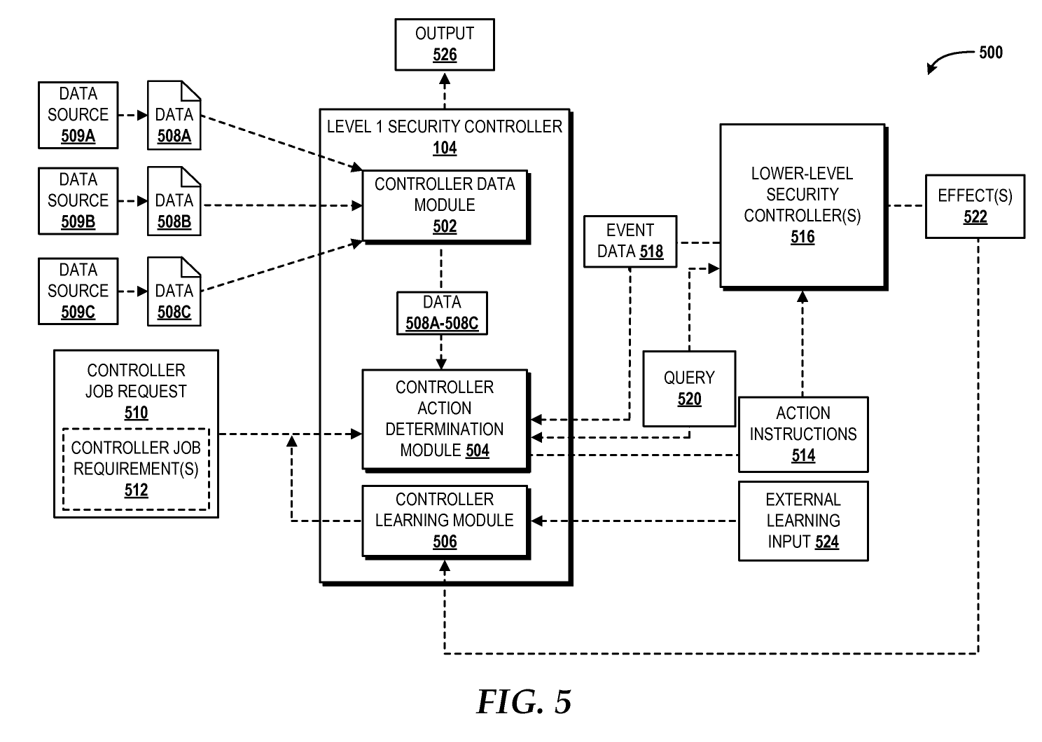

The personal security agent 102 and the security controllers 104-108 can utilize one or more machine learning algorithms to learn about the protected entity, to determine behavior anomalies that may indicate security threats to the protected entity, and to adapt to security threats. The personal security agent 102, in some embodiments, can function without interaction with the protected entity. In some other embodiments, the entity can interact with the personal security agent 102, for example, to query the personal security agent 102 for insight regarding an operation performed by or to be performed by the personal security agent 102 and/or one or more of the security controllers 104-108. The personal security agent 102 also can utilize data from one or more data sources and results from analytics as input for making determinations regarding how to deploy and execute security mechanisms to provide security tailored to a specific entity. Additional details regarding the personal security agent 102 will be described herein below with reference to FIG. 3. Additional details regarding the security controllers 104-108 will be described below with reference to FIG. 5.

The level 1 security controller(s) 104 can provide feedback from execution of one or more actions to the personal security agent 102. The personal security agent 102 can utilize this feedback as input to a machine learning algorithm to improve future decisions regarding the use of the level 1 security controller(s) 104 for execution of one or more actions and/or other aspects of security tailored to the protected entity. Likewise, the level 2 security controller(s) 106 can provide feedback from execution of one or more actions to the level 1 security controller(s) 104. The level 2 security controller(s) 106 can utilize this feedback as input to a machine learning algorithm to improve future decisions regarding the use of the level 2 security controller(s) 106 for execution of one or more actions and/or other aspects of security tailored to the protected entity. The level N security controller(s) 108 similarly can provide feedback from execution of one or more actions to the level 2 security controller(s) 106, and so forth. The personal security agent 102, in some embodiments, can receive feedback from any of the security controllers 104-108 operating in any of the security controller planes 110.

In the manner described above, the personal security agent 102 provides high-level logic to control the overall security of an entity. The personal security agent 102 also interacts with lower-level security controllers, such as the security controllers 104-108, which provide lower-level logic to monitor and interact with specific domains and equipment operating within the domains, such as the equipment 112 operating within the within the equipment plane 114. It should be understood that although the equipment plane 114 is shown having the equipment 112 operating at the control of the level N security controllers 108 operating within the level N security controller plane 110C, the equipment plane 114 may include equipment operating in one or more domains (e.g., home and work) at the control of the same or different security controllers operating in the same or different security controller plane(s). Several illustrative examples using various equipment types will be described herein below in detail. It also should be understood that more or less security controller planes each having more or less security controllers may be under the control of the personal security agent 102. As such, the example provided in FIG. 1 and the other FIGURES described herein should be understood as being illustrative, and should not be construed as being limiting in any way.

The personal security agent 102 and the security controllers 104-108, in some embodiments, are software components that each includes instructions that can be executed by one or more processors of one or more computing systems or devices to perform one or more operations described herein. In the illustrated example, the personal security agent 102 and the security controllers 104-108 can be executed by one or more compute resources 116 that can utilize one or more storage resources 118 and/or one or more other resources 120 to provide an execution environment within a network 122 for the personal security agent 102 and the security controllers 104-108.

The compute resources 116 can include physical hardware resources such as processing resources, memory resources, graphics resources, network resources, input resources, output resources, combinations thereof, and the like. The compute resources 116 can also include virtualized hardware resources that execute upon the physical hardware resources. In either case, the compute resources 116 can facilitate computational processes for executing the personal security agent 102 and the security controllers 104-108. The personal security agent 102 and the security controllers 104-108 may be executed by the same or different compute resources 116. Moreover, the compute resources 116 may be co-located or distributed.

The storage resources 118 can include physical hardware resources such as, but not limited to, hard disks, optical disks, flash memory drives, solid-state drives, combinations thereof, and the like. The storage resources 118 also can include virtualized storage resources. In either case, the storage resources 118 can facilitate storage for the personal security agent 102 and the security controllers 104-108 and data associated therewith. The personal security agent 102, the security controllers 104-108, and/or data associated therewith may be stored by the same or different storage resources 118. Moreover, the storage resources 118 may be co-located or distributed.

The other resources 120 can include any other physical and/or virtualized resources that can be utilized the personal security agent 102 and/or the security controllers 104-108. The compute resources 116, the storage resources 118, and the other resources 120 may be or may include a cloud computing environment for implementing the personal security agent 102 and/or the security controllers 104-108. Alternatively, the compute resources 116, the storage resources 118, and/or the other resources 120 may be provided by one or more computing systems or devices for facilitating the tailored security aspects described herein.

The network 122 can be or can include, for example, a communication network such as the Internet, an intranet, a LAN, or a WAN. The network 122 can provide connectivity among the compute resources 116, the storage resources 118, the other resources 120, the personal security agent 102, the level 1 security controllers 104, the level 2 security controllers 106, the level N security controllers 108, and/or the equipment 112 in any combination.

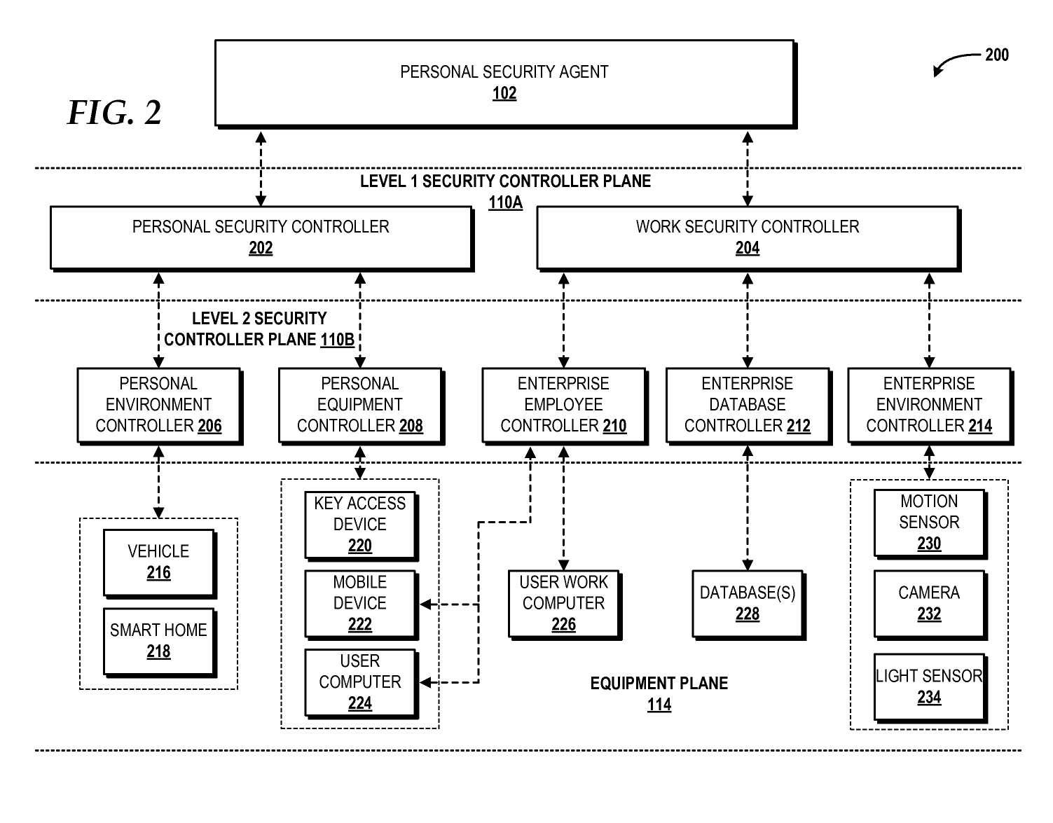

Turning now to FIG. 2, a diagram illustrating an example implementation 200 of the personal security agent 102 for an entity that uses equipment operating within a personal domain and a work domain will be described, according to another illustrative embodiment. The personal security agent 102, in the illustrated embodiment, controls security for an entity embodied as a user who utilizes equipment operating within a personal domain and a work domain. More particularly, the personal security agent 102 controls security operations performed by a personal security controller 202 and a work security controller 204 that operate within a personal domain and a work domain, respectively, and within the level 1 security controller plane 110A. The personal security controller 202 controls security operations of a personal environment controller 206 and a personal equipment controller 208 operating within the level 2 security controller plane 110B. The work security controller 204 controls security operations of an enterprise employee controller 210, an enterprise database controller 212, and an enterprise environment controller 214 also operating within the level 2 security controller plane 110B.

The personal environment controller 206 controls security operations of a vehicle 216 and a smart home 218 that operate within the equipment plane 114. The personal equipment controller 208 controls security operations of a key access device 220 (e.g., a key fob for the vehicle 216, a garage door opener, or a hardware key), a mobile device 222, and a user computer 224. The enterprise employee controller 210 controls security operations of the mobile device 222 and the user computer 224 with regard to security of an enterprise (e.g., the workplace of the user), in addition to a user work computer 226. The enterprise database controller 212 controls security operations of one or more databases 228. The enterprise environment controller 214 controls security operations of a motion sensor 230, a camera 232, and a light sensor 234.

The personal security agent 102 can determine one or more actions to be performed to provide tailored security for the user when the user uses equipment within the personal domain and the work domain. The personal security agent 102 can provide instructions for performing the action(s) to the personal security controller 202 and/or the work security controller 204 operating within the level 1 security controller plane 110A. The personal security controller 202 and/or the work security controller 204 can receive instructions from the personal security agent 102, determine how to perform one or more actions to execute one or more security operations for the protected user based at least in part upon the instructions, and perform one or more actions to execute the security operation(s) for the protected user. An action may include an action performed by the personal security controller 202 and/or the work security controller 204 and/or by one or more devices, computing systems, or the like within a domain under at least partial control of the personal security controller 202 and/or the work security controller 204. An action alternatively may include instructing the personal environment controller 206, the personal equipment controller 208, the enterprise employee controller 210, the enterprise database controller 212, and/or the enterprise environment controller 214 operating within the level 2 security controller plane 110B to perform one or more actions to execute one or more security operations for the protected user.

The personal environment controller 206 and the personal equipment controller 208 can receive instructions from the personal security controller 202, determine how to perform one or more actions to execute one or more security operations for the protected user based at least in part upon the instructions, and perform one or more actions to execute the security operation(s) for the protected user. An action, in the illustrated example, may include the personal environment controller 206 instructing the vehicle 216 and/or the smart home 218 to perform one or more operations to provide security for the protected user. Likewise, an action may include the personal equipment controller 208 instructing the key access device 220, the mobile device 222, and/or the user computer 224 to perform one or more operations to provide security for the protected user.

The enterprise employee controller 210, the enterprise database controller 212, and/or the enterprise environment controller 214 can receive instructions from the work security controller 204, determine how to perform one or more actions to execute one or more security operations for the protected user based at least in part upon the instructions, and perform one or more actions to execute the security operation(s) for the protected user. An action, in the illustrated example, may include the enterprise employee controller 210 instructing the user work computer 226, the mobile device 222, and/or the user computer 224 to perform one or more operations to provide security for the protected user. Likewise, an action may include the enterprise database controller 212 instructing database(s) 228 to perform one or more operations to provide security for the protected user. The enterprise environment controller 214 can instruct the motion sensor 230, the camera 232, and/or the light sensor 234 to perform one or more one or more operations to provide security for the protected user.

It should be understood that security controllers and equipment illustrated and described with reference to FIG. 2 are merely illustrative to show one implementation scenario for the personal security agent 102 that provides tailored security to a user. As such, the security controllers and equipment shown in FIG. 2 should not be construed as being limiting in any way.

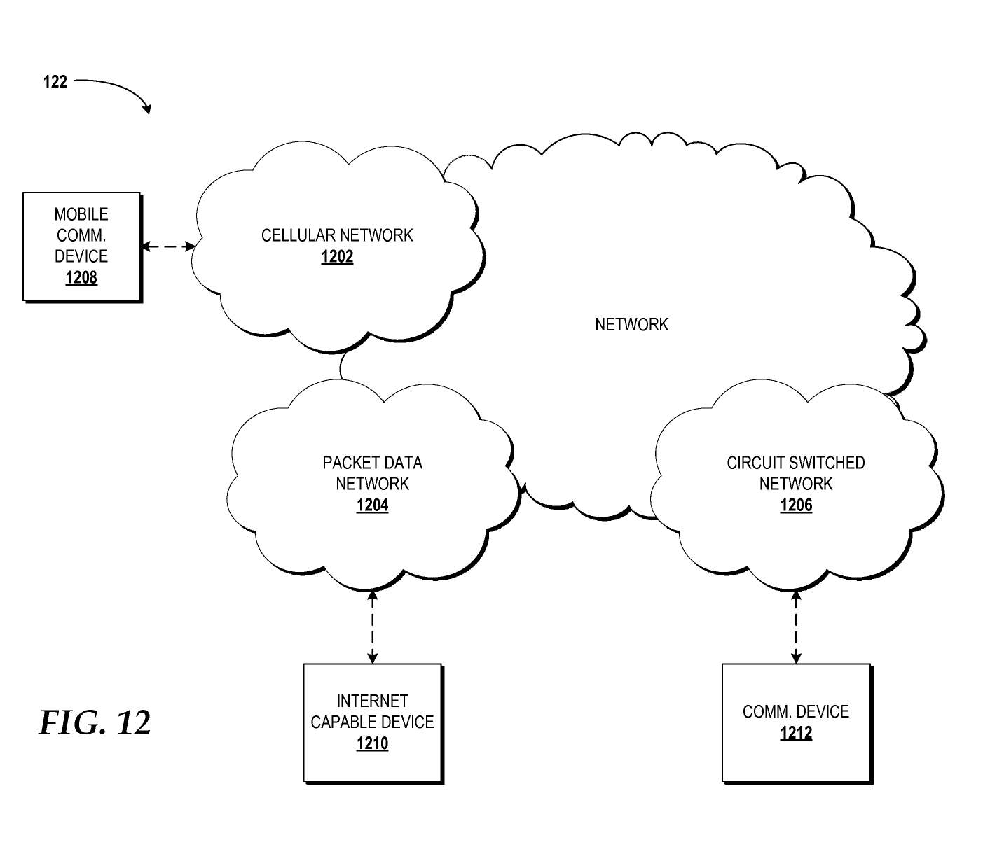

Turning now to FIG. 3, a personal security agent architecture 300 illustrating aspects of the personal security agent 102 will be described, according to an illustrative embodiment. The illustrated personal security agent 102 includes a data module 302, an action determination module 304, and a learning module 306. The data module 302, the action determination module 304, and the learning module 306 can be implemented in software, firmware, hardware, or a combination thereof. For purposes of explanation, and not limitation, the data module 302, the action determination module 304, and the learning module 306 will be described as software modules that perform the operations described below upon execution by one or more processors (best shown in FIG. 12). The software modules can be discrete software programs or may be combined in a single software program. Moreover, the data module 302, the action determination module 304, and the learning module 306 can be executed by one or more processors of a single or multi-processor computing system, or may be executed by two or more computing systems, each of which include one or more processors. Virtualized computing systems, such as made available as compute resources, such as the compute resources 116, via a cloud computing environment, may additionally or alternatively be utilized to execute the software modules shown in FIG. 3.

The data module 302 can receive data 308A-308C from one or more data sources 309A-309C. The data sources 309A-309C can be, but are not limited to, one or more databases, one or more application servers, one or more file servers, one or more motions sensors, one or more accelerometers, one or more light sensors, one or more global positioning systems (“GPSs”), one or more proximity sensors, one or more temperature sensors, one or more gyroscopes, one or more microphones, and the like. The data 308A-308C can include, but is not limited to, environmental data (e.g., temperature, light, motion, sound, and the like), contextual data (e.g., location, orientation, velocity, proximity, and the like), and other data associated with one or more activities of the protected user. The data module 302 can provide at least a portion of the data 308A-308C received from the data sources 309A-309C to the action determination module 304.

The action determination module 304 also can receive a job request 310. The job request 310 can include one or more job requirements 312 to be fulfilled by the personal security agent 102. For example, the job request 310 can be of different levels of complexity ranging from a temperature check and/or other sensor check to more abstract questions, such as whether the user is authorized to access an assets based upon information known about the protected user (e.g., location, status, current job description, current tasks, and the like). The job requirements 312 can be an expected value or value range required for the job request 310 to be fulfilled.

The action determination module 304 can analyze the data 308A-308C and the job request 310 to determine action instructions 314. One simple, non-limiting example is a request to maintain correct temperature in a given room, to grant certain access privileges for designated personnel when the personnel arrive at the room, and to remove access once the personnel leave the room. The action instructions 314 can be directed towards one or more security controllers operating within a controller domain 316, and can include instructions that instruct the security controller(s) to perform one or more actions. The controller domain 316 can include, for example, one or more of the security controllers 104-108 operating in one or more of the security controller planes 110 described above with reference to FIG. 1. The controller domain 316 can receive the action instructions 314 from the action determination module 304 and, in response, the security controller(s) to which the action instructions 314 are directed can perform the designated action(s).

In some instances, one or more security controllers operating within the controller domain 316 can provide event data 318 to the action determination module 304. The event data 318 can be results in reply to a query 320. For example, positive or negative validation of an authentication request of an entity, or results of ongoing data collection. Alternatively, the event data 318 can be or can include an out-of-band notification of event that is occurring. Even if the personal security agent 102 did not specifically request the notification, the notification might still fall under a general area/importance for which one or more of the security controllers 104-108 will send event status, such as, for example, an ongoing malicious event (e.g., denial-of-service attack, break-in attempt, or phishing) as detected by one or more sensors controlled by the controller(s) 104-108. Another example is an equipment failure or failures that the personal security agent 102 needs to know about.

The event data 318 can be utilized by the action determination module 304 to determine additional action instructions 314 that can be sent to the controller domain 316 to cause the security controller(s) to perform additional actions or to modify previous action instructions 314. In some instances, one or more security controllers operating within the controller domain 316 can provide to the query 320 to the action determination module 304 for at least a portion of the data 308A-308C, which can then be used by the security controller(s) for performance of one or more action(s).

Actions performed by security controllers operating within the controller domain 316 can result in one or more effects 322. The effect(s) 322 can include the event data 318 in addition to metadata, such as, for example, statistical information about an event, changes and consequences of the event, how other elements associated with the event are affects, and the like. The personal security agent 102 can determine cause and effect relationships and can determine conclusions for similar events in the future. The effect(s) 322 can be utilized by the learning module 306 as input for a machine learning algorithm that can provide feedback to the action determination module 304 regarding information learned about the protected entity, behavior anomalies that may indicate security threats to the protected entity, and information that can be utilized by the action determination module 304 to generate action instructions 314 in response to security threats.

The learning module 306 can alternatively or additionally utilize external learning input 324, such as, for example, data from one or more controllers, learning data sets, data from external systems and/or device, and the like, as input for a machine learning algorithm that can provide feedback to the action determination module 304 regarding information learned about the protected entity, behavior anomalies that may indicate security threats to the protected entity, and information that can be utilized by the action determination module 304 to generate action instructions 314 in response to security threats.

The personal security agent 102 can provide output 326. The output 326 can be or can include one or more alerts to be used to inform a protected entity of potential threats. The output 326 can be or can include one or more actions that should be performed to mitigate or prevent an attack.

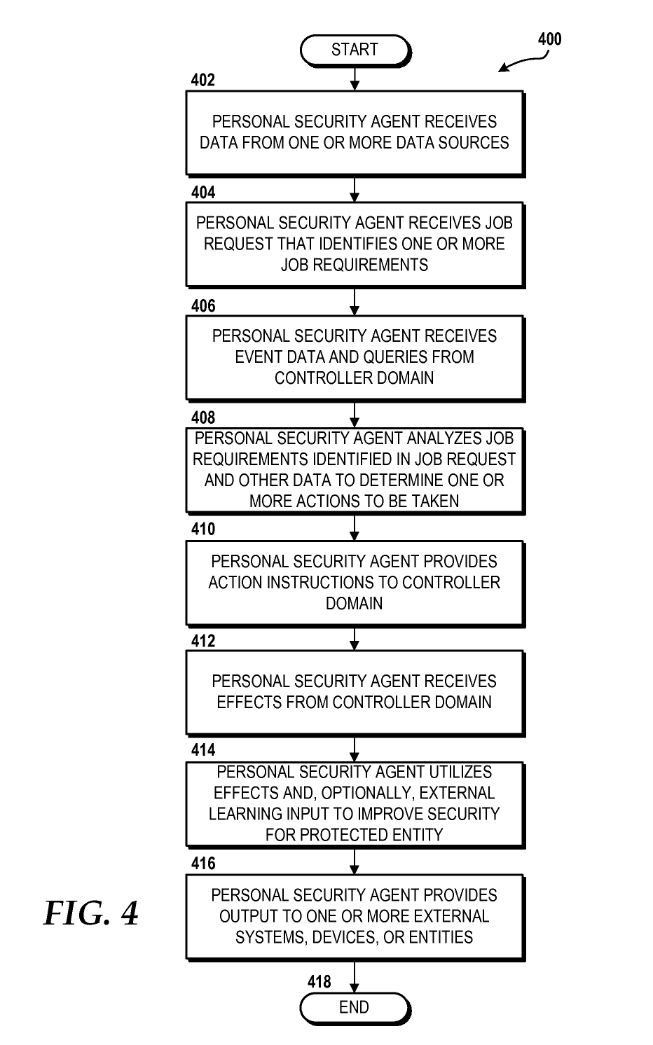

Turning now to FIG. 4, a method 400 for providing personalized security for an entity via the personal security agent 102 will be described, according to an illustrative embodiment. The method 400 will be described with reference to FIGS. 3 and 4.

It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device to perform one or more operations and/or causing the processor to direct other components of the computing system or device to perform one or more of the operations.

For purposes of illustrating and describing the concepts of the present disclosure, operations of the methods disclosed herein are described as being performed by a computing system via execution of one or more software modules such as, for example, the data module 302, the action determination module 304, the learning module 306, and other modules and software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 400 begins and proceeds to operation 402, where the personal security agent 102 receives the data 308A-308C from one or more of the data sources 309A-309C. From operation 402, the method 400 proceeds to operation 404, the personal security agent 102 receives the job request 310 that includes one or more of the job requirements 312. From operation 404, the method 400 proceeds to operation 406, where the personal security agent 102 receives the event data 318 and one or more queries 320 from the controller domain 316.

From operation 406, the method 400 proceeds to operation 408, where the personal security agent 102 analyzes the job requirements 312 to determine one or more actions to be taken by the personal security agent 102 to meet the job requirements 312. In addition, at operation 408, the personal security agent 102 can analyze other data, including the data 308A-308C, the event data 318, and/or the query/queries 320 to refine the determination of one or more actions to be taken by the personal security agent 102 to meet the job requirements 312.

From operation 408, the method 400 proceeds to operation 410, where the personal security agent 102 provides the action instructions 314 to the controller domain 316 to instruct one or more controllers operating within the controller domain 316 to perform the action(s) determined at operation 408. In response, at operation 412, the personal security agent 102 receives one or more of the effects 322 as a result of the controllers operating within the controller domain 316 performing the requested action(s) per the action instructions 314.

From operation 412, the method 400 proceeds to operation 414, the personal security agent 102 utilizes the effect(s) 322 received from the controller domain at operation 412 as input to a learning algorithm executed by the personal security agent 102 to improve security for the protected entity. The personal security agent 102 may additionally utilize the external learning input 324 to further refine the learning algorithm. From operation 414, the method 400 proceeds to operation 414, where the personal security agent 102 provides the output 326 to one or more external systems, devices, or entities, for example.

From operation 414, the method 400 proceeds to operation 418. The method 400 ends at operation 418.

Turning now to FIG. 5, a diagram illustrating aspects of a security controller architecture 500 will be described, according to an illustrative embodiment. The illustrated security controller is one of the level 1 security controllers 104 illustrated in FIG. 1, however, the other security controllers illustrated and described herein may utilize an architecture that is the same as or similar to the security controller architecture 500.

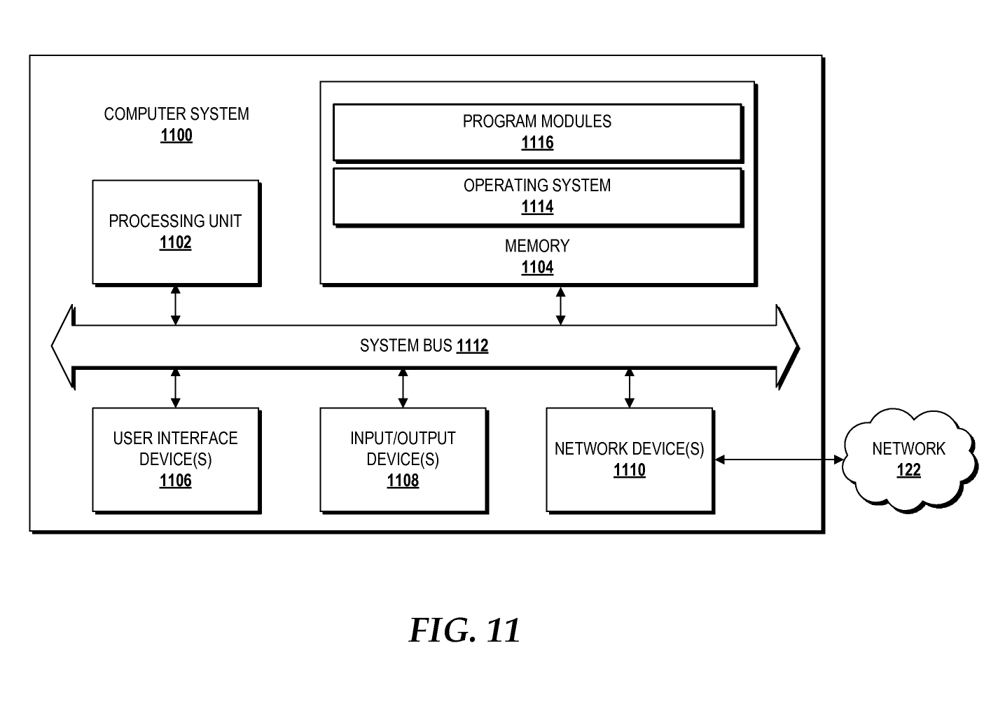

The illustrated level 1 security controller 104 includes a controller data module 502, a controller action determination module 504, and a controller learning module 506. The controller data module 502, the controller action determination module 504, and the controller learning module 506 can be implemented in software, firmware, hardware, or a combination thereof. For purposes of explanation, and not limitation, the controller data module 502, the controller action determination module 504, and the controller learning module 506 will be described as software modules that perform the operations described below upon execution by one or more processors (best shown in FIG. 11). The software modules can be discrete software programs or may be combined in a single software program. Moreover, the controller data module 502, the controller action determination module 504, and the controller learning module 506 can be executed by one or more processors of a single or multi-processor computing system, or may be executed by two or more computing systems, each of which include one or more processors. Virtualized computing systems, such as made available as compute resources, such as the compute resources 116, via a cloud computing environment, may additionally or alternatively be utilized to execute the software modules shown in FIG. 5.

The controller data module 502 can receive data 508A-508C from one or more data sources 509A-509C. The data sources 509A-509C can be, but are not limited to, one or more databases, one or more application servers, one or more file servers, one or more motions sensors, one or more accelerometers, one or more light sensors, one or more global positioning systems (“GPSs”), one or more proximity sensors, one or more temperature sensors, one or more gyroscopes, one or more microphones, and the like. The data 508A-508C can include, but is not limited to, environmental data (e.g., temperature, light, motion, sound, and the like), contextual data (e.g., location, orientation, velocity, proximity, and the like), and other data associated with one or more activities of the protected user. The controller data module 502 can provide at least a portion of the data 508A-508C received from the data sources 509A-509C to the controller action determination module 504.

The controller action determination module 504 also can receive a controller job request 510. The controller job request 510 can include one or more controller job requirements 512 to be fulfilled by the level 1 security controller 104. For example, the job request 310 can be of different levels of complexity ranging from a temperature check and/or other sensor check to more abstract questions, such as whether the user is authorized to access an assets based upon information known about the protected user (e.g., location, status, current job description, current tasks, and the like). The job requirements 312 can be an expected value or value range required for the job request 310 to be fulfilled.

The controller action determination module 504 can analyze the data 508A-508C and the controller job request 510 to determine controller action instructions 514. One simple, non-limiting example is a request to maintain correct temperature in a given room, to grant certain access privileges for designated personnel when the personnel arrive at the room, and to remove access once the personnel leave the room. The controller action instructions 514 can be directed towards one or more lower-level security controllers 516, and can include instructions that instruct the lower-level security controller(s) 516 to perform one or more actions. The lower-level security controller(s) 516 can include, for example, one or more of the level 2 security controllers 106A-106C and/or one or more the level N security controllers 108A-108C described above with reference to FIG. 1. The lower-level security controller(s) 516 can receive the controller action instructions 514 from the controller action determination module 504 and, in response, the lower-level security controller(s) 516 to which the action instructions 514 are directed can perform the designated controller action(s).

In some instances, one or more of the lower-level security controllers 516 can provide event data 518 to the action determination module 504. The event data 518 can be results in reply to a query 520. For example, positive or negative validation of an authentication request of an entity, or results of ongoing data collection. Alternatively, the event data 518 can be or can include an out-of-band notification of event that is occurring. Even if the lower-level security controllers 516 did not specifically request the notification, the notification might still fall under a general area/importance for which one or more of the lower-level security controllers 516 will send event status, such as, for example, an ongoing malicious event (e.g., denial-of-service attack, break-in attempt, or phishing) as detected by one or more sensors controlled by the lower-level security controllers 516. Another example is an equipment failure or failures that the personal security agent 102 needs to know about. The event data 518 can be utilized by the controller action determination module 504 to determine additional action instructions 514 that can be sent to the lower-level security controller(s) 516 to cause the lower-level security controllers 516 to perform additional actions or to modify previous action instructions 514. In some instances, one or more of the lower-level security controllers 516 can provide the query 520 the controller action determination module 504 for at least a portion of the data 508A-508C, which can then be used by the lower-level security controller(s) 516 for performance of one or more action(s).

Actions performed by the lower-level security controllers 516 can result in one or more effects 522. The effect(s) 522 can include the event data 518 in addition to metadata, such as, for example, statistical information about an event, changes and consequences of the event, how other elements associated with the event are affects, and the like. The security controller 104 can determine cause and effect relationships and can determine conclusions for similar events in the future. The effect(s) 522 can be utilized by the controller learning module 506 as input for a machine learning algorithm that can provide feedback to the controller action determination module 504 regarding information learned about the protected entity, behavior anomalies that may indicate security threats to the protected entity, and information that can be utilized by the controller action determination module 504 to generate action instructions 514 in response to security threats.

The learning module 506 can alternatively or additionally utilize external learning input 524, such as, for example, data from one or more controllers, learning data sets, data from external systems and/or device, and the like, as input for a machine learning algorithm that can provide feedback to the controller action determination module 504 regarding information learned about the protected entity, behavior anomalies that may indicate security threats to the protected entity, and information that can be utilized by the controller action determination module 504 to generate action instructions 514 in response to security threats.

The level 1 security controller 104 can provide output 526. The output 526 can be or can include one or more alerts to be used to inform a protected entity of potential threats. The output 526 can be or can include one or more actions that should be performed to mitigate or prevent an attack.

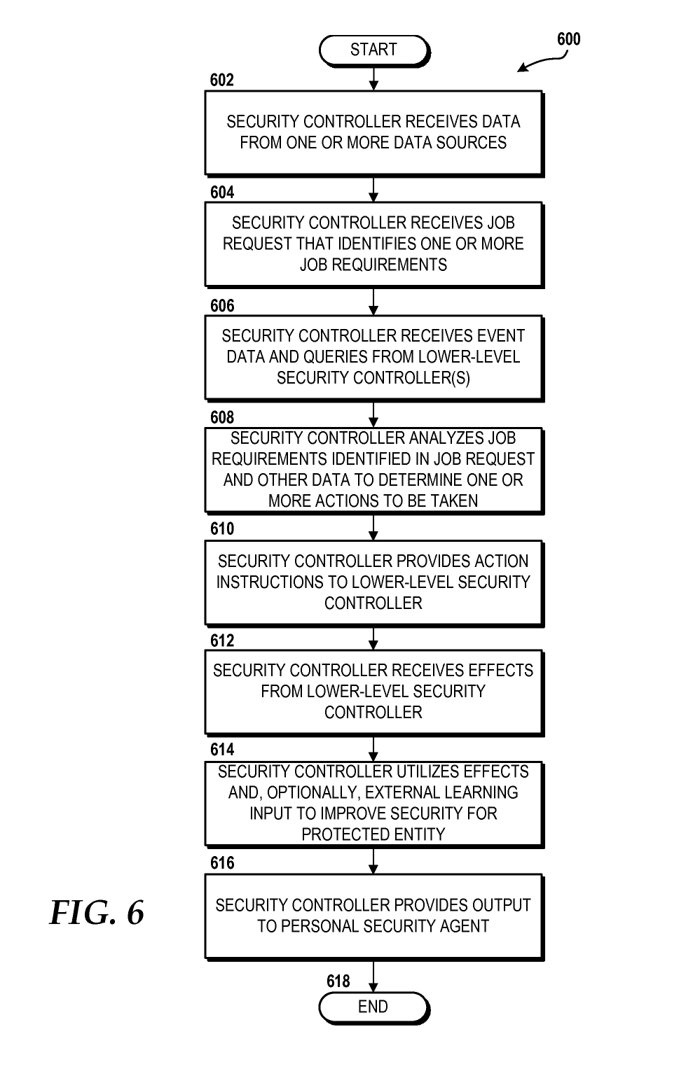

Turning now to FIG. 6, a method 600 for providing personalized security for an entity via a security controller, such as the level 1 security controller 104, will be described, according to an illustrative embodiment. The method 600 will be described with reference to FIGS. 5 and 6.

The method 600 begins and proceeds to operation 602, where the level 1 security controller 104 receives the data 508A-508C from one or more of the data sources 509A-509C. From operation 602, the method 600 proceeds to operation 604, where the level 1 security controller 104 receives the controller job request 510 that includes one or more of the controller job requirements 512. From operation 604, the method 600 proceeds to operation 606, where the level 1 security controller 104 receives the event data 518 and one or more queries 520 from the lower-level security controller(s) 516.

From operation 606, the method 600 proceeds to operation 608, where the level 1 security controller 104 analyzes the controller job requirements 512 to determine one or more actions to be taken by the level 1 security controller 104 to meet the controller job requirements 512. In addition, at operation 608, the level 1 security controller 104 can analyze other data, including the data 508A-508C, the event data 518, and/or the query/queries 520 to refine the determination of one or more actions to be taken by the level 1 security controller 104 to meet the controller job requirements 512.

From operation 608, the method 600 proceeds to operation 610, where the level 1 security controller 104 provides the action instructions 514 to the lower-level security controller(s) 516 to instruct the lower-level security controller(s) 516 to perform the action(s) determined at operation 608. In response, at operation 612, the level 1 security controller 104 receives one or more of the effects 522 as a result of the lower-level security controller(s) 516 performing the requested action(s) per the action instructions 514.

From operation 612, the method 600 proceeds to operation 614, where the level 1 security controller 104 utilizes the effect(s) 522 received from the lower-level security controller(s) 516 at operation 612 as input to a learning algorithm executed by the level 1 security controller 104 to improve security for the protected entity. The level 1 security controller 104 may additionally utilize the external learning input 524 to further refine the learning algorithm. From operation 614, the method 600 proceeds to operation 616, where the level 1 security controller 104 provides the output 526 to one or more external systems, devices, or entities, for example.

From operation 616, the method 600 proceeds to operation 618. The method 600 ends at operation 618.

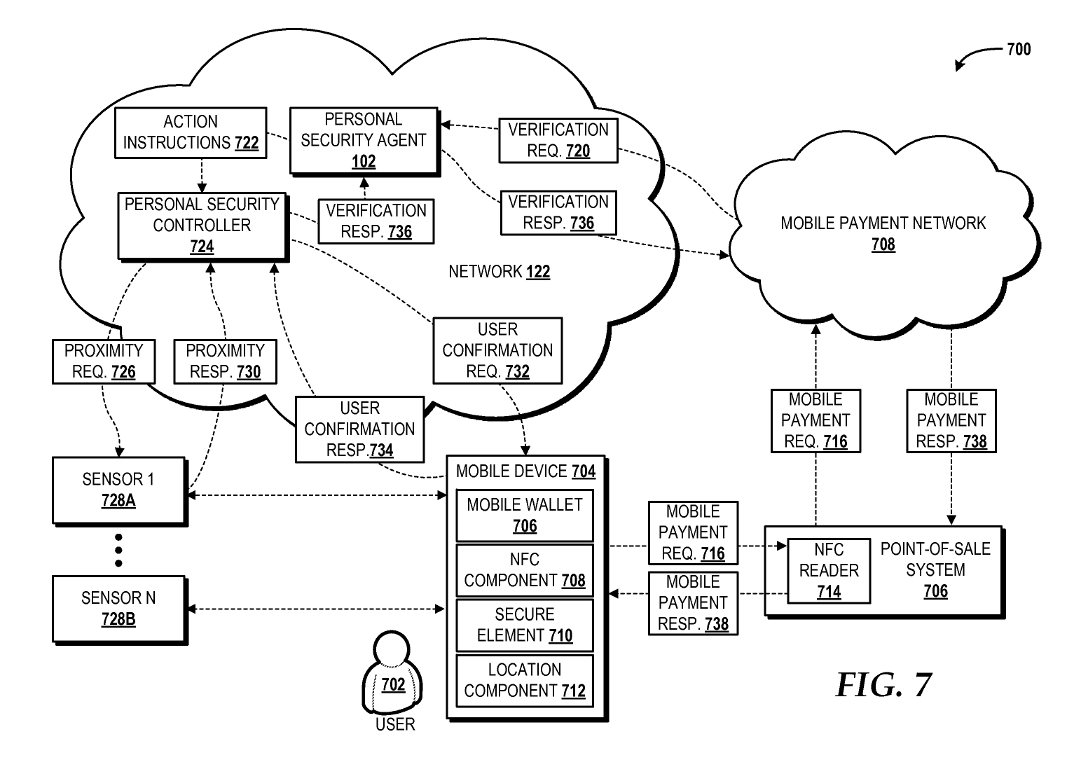

Turning now to FIG. 7, aspects of a financial transaction scenario 700 in which the personal security agent 102 is utilized to provide personalized security for an entity, such as a user 702, during a financial transaction will be described, according to an illustrative embodiment. The financial transaction scenario 700 illustrates the user 702 who is associated with a mobile device 704. The user 702 may be in a store or other environment in which he or she desires to purchase goods and/or services using a mobile payment method facilitated, at least in part, by the mobile device 704, a point-of-sale (“POS”) system 706, and a mobile payment network 708.

The illustrated mobile device 704 includes a mobile wallet 706, a near-field communications (“NFC”) component 708, a secure element 710, and a location component 712. The mobile wallet 706 can be a software application that manages payment account information (e.g., credit card or debit card information). The payment account information may be encrypted and stored in the secure element 710. The NFC component 708 can utilize NFC technology to enable a contactless communication path between the NFC component 708 and an NFC reader 714 operating as part of or in communication with the POS system 706. The mobile wallet 706 can instruct the NFC component 708 to provide a mobile payment request 716 to the NFC reader 714 via the contactless communication path. The mobile payment request 716 can include payment account information to be used as payment for goods and/or services.

The POS 706 can receive the mobile payment request 714 from the NFC reader 714 and can provide the mobile payment request 716 to the mobile payment network 708. The mobile payment network 708, in some embodiments, is or includes components of ISIS, available from JVL Ventures, LLC, and/or GOOGLE WALLET, available from GOOGLE PAYMENT CORP. Other mobile payment networks are contemplated, and as such, these example embodiments should not be construed as being limiting in any way.

The mobile payment network 708 can receive the mobile payment request 716 from the POS system 706. The mobile payment network 708 can coordinate with the personal security agent 102 operating within the network 122 to verify the user 702 and, in this manner, determine whether the transaction between the mobile device 704 and the POS system 706 was initiated by the user 702 instead of another entity masquerading as the user 702. In particular, the mobile payment network 708 can provide a verification request 720 to the personal security agent 102. The verification request 720 can serve as a job request for the personal security agent 102. As such, the personal security agent 102 can utilize the verification request 720 and other data, if available, to determine one or more actions that should be taken to meet one or more job requirements of the job request, which, in this example, may include verification of the user's 102 identity, location, and amount of payment. The personal security agent 102 can generate action instructions 722 for the action(s) and send the action instructions 722 to a personal security controller 724.

The personal security controller 724 can function, for example, as a level 1 security controller, such as one of the level 1 security controllers 104 described above with reference to FIG. 1. The personal security controller 724, in the illustrated example, provides a proximity request 726 to one or more sensors 728A-728B associated with the user 702. The proximity request 726 can be used to determine whether or not the sensor(s) 728 are within proximity of the mobile device 704 and therefore likely with the user 702. The sensor(s) 728 can respond to the proximity request 726 with a proximity response 730 indicating whether or not the sensor(s) 728 are within proximity of the mobile device 704. The proximity may be determined, in some embodiments, based upon the availability of a communication path between the sensor(s) 728 and the mobile device 704. For example, the sensor(s) 728 may communicate with the mobile device 704 via a short-range communications technology such as, but not limited to, BLUETOOTH, BLUETOOTH low energy, NFC, adhoc WI-FI, ZIGBEE, combinations thereof, and the like.

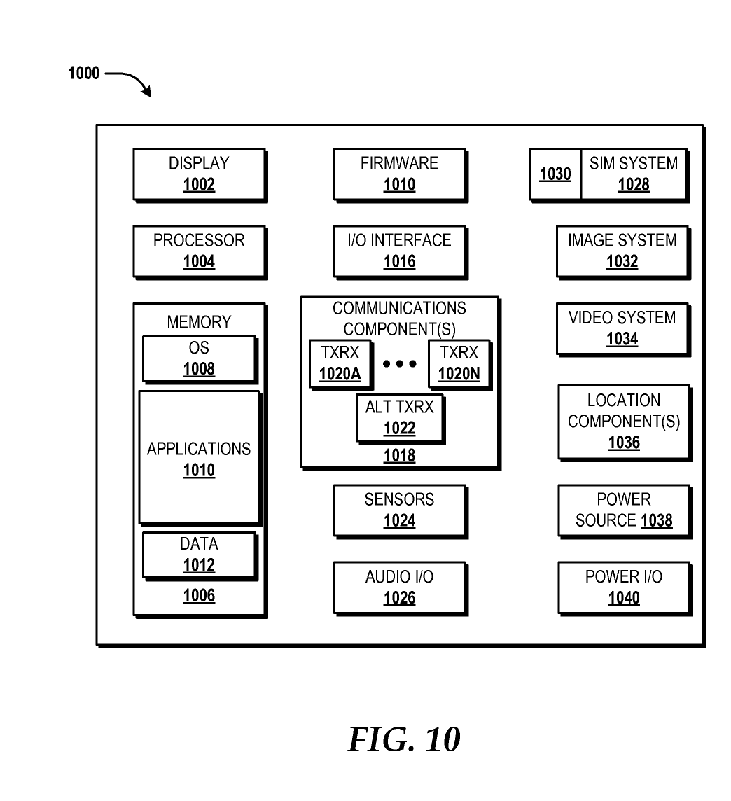

The personal security controller 724, in the illustrated example, also provides a user confirmation request 732 to the mobile device 704. The user confirmation request 732 can include a request to verify the location of the mobile device 704. The mobile device 704 can determine a location of the mobile device 704 and can provide the location to the personal security controller 724 in a user confirmation response 734. In some embodiments, the mobile device 704 can determine a location of the mobile device 704 using the location component 712. The location component 712 can be configured to send and/or receive signals to determine a location of the mobile device 704. According to various embodiments, the location component 712 can send and/or receive signals from global positioning system (“GPS”) devices, assisted-GPS (“A-GPS”) devices, WI-FI/WIMAX and/or cellular network triangulation data, combinations thereof, and the like. The location component 712 also can be configured to communicate with one or more transceivers of the mobile device 704 (best shown in FIG. 10) to retrieve triangulation data for determining a location of the mobile device 704. In some embodiments, the location component 712 can interface with cellular network nodes, telephone lines, satellites, location transmitters and/or beacons, wireless network transmitters and receivers, combinations thereof, and the like. In some embodiments, the location component 712 can include and/or can communicate with one or more of the sensors 728, and/or other sensors (not shown) included in the mobile device 704, such as, for example, a compass, an accelerometer, and/or a gyroscope to determine the orientation of the mobile device 704. Using the location component 712, the mobile device 704 can generate and/or receive data to identify a geographic location, or to transmit data used by other devices to determine the location of the mobile device 704. The location component 712 may include multiple components for determining the location and/or orientation of the mobile device 704.

The user confirmation request 732 also can include a request for the user 702 to verify the amount of the mobile payment request 716. For example, the user confirmation request 732 can instruct the mobile device 704 to present an audio and/or visual prompt that requests the user 702 to verify the payment amount identified in the mobile payment request 716. The user confirmation response 734 can include the payment amount, if any, input by the user 702 in response to the prompt.

The personal security controller 724 can use data from the proximity response 730 and the user confirmation response 734 to determine whether or not the user 702 was in fact the one that initiated the mobile payment request 716, and therefore verified for the purpose of authorizing payment in response to the mobile payment request 716. The personal security controller 724 can provide a verification response 736 to the personal security agent 102 that, in turn, can provide the verification response 736 to the mobile payment network 708. The verification response 736 can include an indication of whether or not the user 702 was in fact the one that initiated the mobile payment request 716. The mobile payment network 708 can use the verification response 736 in consideration of allowing or not payment from the mobile device 704. The mobile payment network 708 can provide a mobile payment response 738 to the POS system 706 indicating whether or not the mobile payment request 714 is accepted.

The POS system 706 can receive the mobile payment response 738 from the mobile payment network 708 and can forward the mobile payment response 738 or a response derivative thereof to the mobile device 704. The mobile payment response 738 can indicate whether payment was accepted or denied. The mobile payment response 738 can include additional information that can be used by the mobile wallet 706 to log the payment.

Turning now to FIG. 8, a diagram illustrating aspects of a malicious short messaging service (“SMS”) message scenario 800 in which personal security agents are utilized to provide personalized security for an entity to prevent malicious SMS messages from being delivered to a device associated with the entity will be described, according to an illustrative embodiment. In the illustrated example, a user A 802A associated with a mobile device A 804A desires to send a SMS message 806 to a user B 802B associated with a mobile device B 804B. Per SMS protocol, the mobile device A 804A can send the SMS message 806 to a SMS center (“SMS-C”) 808. The SMS-C 808 can receive the SMS message 806 and can forward message information 810 about the SMS message 806 to a personal security agent for user B (“personal security agent B”) 812B. The message information 810 can include a source address that identifies the source of the SMS message 806. The source, in the illustrated example, is the mobile device A 804A. The source address can include, for example, a telephone number or other identifier that can be used to identify the mobile device A 804A as the source of the SMS message 806.

The personal security agent B 812B can receive the source address in the message information 810 and can determine, based at least in part upon the source address, whether or not the SMS message 806 is suspicious. The personal security agent B 812B can determine that the SMS message 806 is suspicious if, for example, the source address is known to have been associated with malicious activity, spam, or other undesirable activity. The personal security agent B 812B can make use of any existing algorithm or query an external expert system for use in a determination of whether or not the SMS message 806 is suspicious.

In response to determining that the SMS message 806 is suspicious, the personal security agent B 812B can generate a flag 814 and can send the flag to the SMS-C 808. The flag 814 can instruct the SMS-C 808 to withhold the SMS message 806 until further instruction.

The personal security agent B 812B also can establish a connection 816 with a personal security agent A 812A associated with the user A 802A. The connection 816 can be a peer-to-peer connection or a connection established via the network 122. The personal security agent B 812B can send a suspicious activity request 820 to the personal security agent A 812A. The personal security agent A 812A, in response, can generate a device check request 822 and can send the device check request 822 to one or more sensors 824A-824B associated with the user A 802A. The sensors 824A-824B can include, but are not limited to, a smart watch, smart glasses, smart jewelry, smart accessories, other smart devices, key access devices (e.g., key fobs), fitness devices (e.g., calorie trackers, heart rate monitors, running watches, and pedometers), sensor(s) worn by the user A 802A, sensor(s) implanted within the user A 802A, sensor(s) tattooed into the skin of the user A 802A, combinations thereof, and the like. The sensors 824A-824B can receive the device check request 822, and in response, can check the mobile device A 804A to determine if the mobile device A 804A has been compromised. For example, the sensors 824A-824B can attempt to communicate with the mobile device A 804A, via BLUETOOTH or other communications protocol, to verify that the mobile device A 804A is located with the user 802A, and therefore also verify that the user A 802A likely sent the SMS message 806. A check of use/liveliness can be performed by employing data other devices have about the user A 802A. The data can include, for example, whether the user A 802A is moving, if the user A 802A accessed the mobile device A 804A recently, and the like.

The sensors 820A-820B can generate a device check response 826 that includes an indication of whether the mobile device A 804A is located with the user 802A and can send the device check response 826 to the personal security agent A 812A. The personal security agent A 812A can receive the device check response 826 from the sensors 824A-824B and can utilize the indication of whether the mobile device A 804A is located with the user 802A in a determination of whether or not the SMS message 806 is to be treated as malicious.

The personal security agent A 812A also can generate a behavior check request 828 and can send the behavior check request 828 to a behavior tracking system 830. The behavior check request 828 can include a request for the behavior tracking system 830 to provide behavior information associated with the user A 802A and/or his or her use of the mobile device A 804A to the personal security agent A 812A. The behavior tracking system 830 can receive the behavior check request 828 and can utilize one or more behavior algorithms 832 and/or behavior data 834 to determine behavior trends. The behavior tracking system 830 can provide the behavior trends and/or other behavior information to the personal security agent A 812A in a behavior check response 836. The personal security agent A 812A can receive the behavior check response 836 from the behavior tracking system 830 and can utilize the behavior trends and/or other behavior information in a determination of whether or not the SMS message 806 is to be treated as malicious.

The personal security agent A 812A can generate a suspicious activity response 834 in reply to the suspicious activity request 820 received from the personal security agent B 812B. The suspicious activity response 838 can include an indication of whether the personal security agent A 812A has determined that the SMS message 806 is malicious based at least in part upon information included in the device check response 826 and/or the behavior check response 836. In some embodiments, the suspicious activity response 838 can instruct the personal security agent B 812B to disregard the SMS message 806 and other messages, if any, from the mobile device A 804A until further notice. The personal security agent A 812A can send the suspicious activity response 838 to the personal security agent B 812B over the connection 816. The personal security agent B 812B can receive the suspicious activity response 838 from the personal security agent A 812A and can generate instructions 840A/840B directed to either the SMS-C 808 (instructions 840A) or the mobile device B 804B (instructions 840B). If the suspicious activity response 838 indicates that the SMS message 806 is not malicious, the instructions 840A can be sent to the SMS-C 808. The SMS-C 808, in response, can forward the SMS message 806 to the mobile device B 804B. Alternatively, if the suspicious activity response 838 indicates that the SMS message 806 is malicious, the instructions 840B can be sent to the mobile device B 804B. The mobile device B 804B, in response, can block any communications from the mobile device A 804A until further notice.

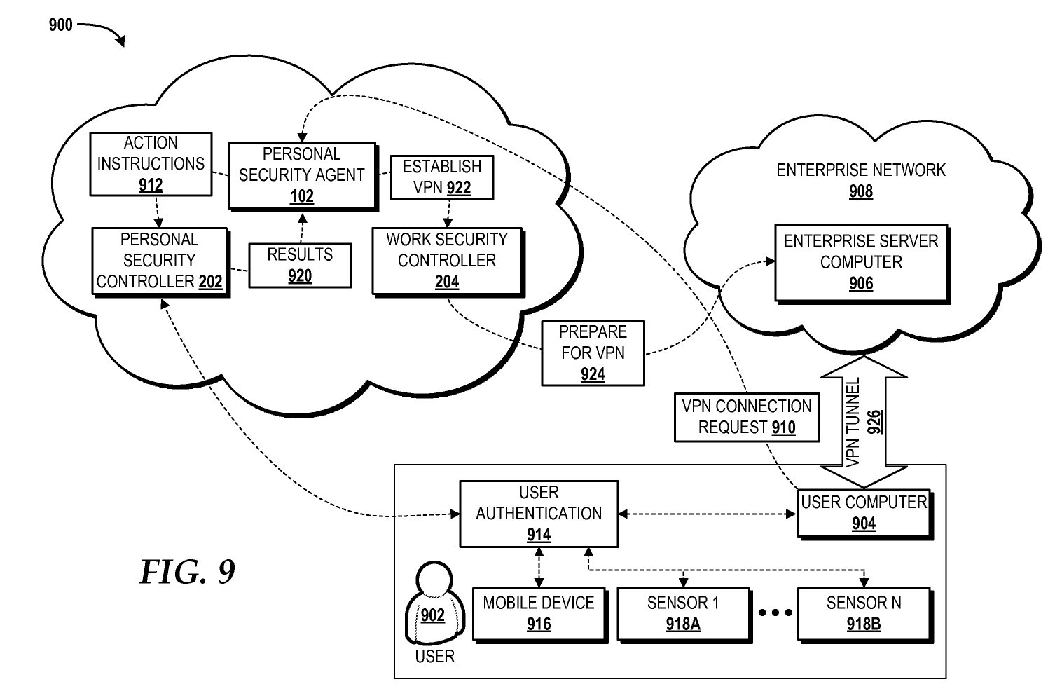

Turning now to FIG. 9, a diagram illustrating aspects of a virtual private network (“VPN”) access scenario 900 in which the personal security agent 102 is utilized to provide personalized security for a user 902 to allow the user 902 VPN access via a user computer 904 to an enterprise server computer 906 operating within an enterprise network 908 will be described, according to an illustrative embodiment. The user 902 can initiate a request to establish a VPN connection over which the user computer 904 can connect to the enterprise server computer 906. The user computer 904, in response, can generate a VPN connection request 910 and can send the VPN connection request 910 to the personal security agent 102. The personal security agent 102 can receive the VPN connection request 910 from the user computer 904, and in response, can generate action instructions 912 directed to the personal security controller 202 to instruct the personal security controller 202 to perform one or more operations to authenticate the user 902 (shown as “user authentication 914”).

In particular, the personal security agent 102 can send an authentication request to a mobile device 916, the user computer 904, one or more sensors 918A-918B, or a combination thereof to determine whether the user 902 in fact initiated the request to establish the VPN connection. For example, the sensors 918A-918B and/or the mobile device 916 can attempt to communicate with the user computer 904 via BLUETOOTH or other communications protocol to verify that the mobile device 916 is located with the user 902, and therefore also verify that the user 902 likely initiated the request to establish the VPN connection. A check of use/liveliness can be performed by employing data other devices have about the user 902. The data can include, for example, whether the user 902 is moving, if the user 902 accessed the mobile device 916 and/or the user computer 904 recently, and the like.

The sensors 918A-918B, the mobile device 916, the user computer 904, or a combination thereof can together or separately generate an authentication response directed to the personal security controller 202. The authentication response(s) can include an indication of whether the sensors 918A-918B, the mobile device 916, the user computer 904, or a combination thereof is located with the user 902. The personal security controller 202 can receive the authentication response(s) and can forward the authentication response(s) to the personal security agent 102 as results 920.

In the illustrated example, the personal security agent 102 determines that the results 920 indicate that the user 902 is authenticated to access the enterprise network 908 via a VPN connection established between the user computer 904 and the enterprise network 908. In response, the personal security agent 102 can send an establish VPN request (“establish VPN 922”) to the work security controller 204. The work security controller 204, in response, can provide to the enterprise server computer 906 instructions to prepare for a VPN connection (“prepare for VPN 924”) initiated by the user computer 904. The instructions can include, for example, an indication that the user 902 is pre-authenticated to access the enterprise network 908 via the user computer 904. In response, the enterprise server computer 906 can establish a VPN tunnel 926 with the user computer 904. The user computer 904 and the enterprise server computer 906 can then exchange information via the VPN tunnel 926.

Turning now to FIG. 10, an illustrative mobile device 1000 and components thereof will be described. In some embodiments, the mobile devices 222, 704, 804A, 804B, and 916 described above can be configured as and/or can have an architecture similar or identical to the mobile device 1000 described herein with respect to FIG. 10. It should be understood, however, that the mobile devices 222, 704, 804A, 804B, and 916 may or may not include the functionality described herein with reference to FIG. 10. While connections are not shown between the various components illustrated in FIG. 10, it should be understood that some, none, or all of the components illustrated in FIG. 10 can be configured to interact with one other to carry out various device functions. In some embodiments, the components are arranged so as to communicate via one or more busses (not shown). Thus, it should be understood that FIG. 10 and the following description are intended to provide a general understanding of a suitable environment in which various aspects of embodiments can be implemented, and should not be construed as being limiting in any way.

As illustrated in FIG. 10, the mobile device 1000 can include a display 1002 for displaying data. According to various embodiments, the display 1002 can be configured to display various graphical user interface (“GUI”) elements, text, images, video, virtual keypads and/or keyboards, messaging data, notification messages, metadata, internet content, device status, time, date, calendar data, device preferences, map and location data, customer service interactions, combinations thereof, and the like. The mobile device 1000 also can include a processor 1004 and a memory or other data storage device (“memory”) 1006. The processor 1004 can be configured to process data and/or can execute computer-executable instructions stored in the memory 1006. The computer-executable instructions executed by the processor 1004 can include, for example, an operating system 1008, one or more applications 1010, other computer-executable instructions stored in a memory 1006, or the like. In some embodiments, the applications 1010 also can include a UI application (not illustrated in FIG. 10).

The UI application can interface with the operating system 1008 to facilitate user interaction with functionality and/or data stored at the mobile device 1000 and/or stored elsewhere. In some embodiments, the operating system 1008 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 1004 to aid a user in answering/initiating calls, entering/deleting other data, entering and setting user IDs and passwords for device access, configuring settings, manipulating address book content and/or settings, multimode interaction, interacting with other applications 1010, and otherwise facilitating user interaction with the operating system 1008, the applications 1010, and/or other types or instances of data 1012 that can be stored at the mobile device 1000.

According to various embodiments, the applications 1010 can include, for example, the mobile wallet 706, a web browser application, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 1010, the data 1012, and/or portions thereof can be stored in the memory 1006 and/or in a firmware 1014, and can be executed by the processor 1004. The firmware 1014 also can store code for execution during device power up and power down operations. It should be appreciated that the firmware 1014 can be stored in a volatile or non-volatile data storage device including, but not limited to, the memory 1006 and/or a portion thereof.

The mobile device 1000 also can include an input/output (“I/O”) interface 1016. The I/O interface 1016 can be configured to support the input/output of data. In some embodiments, the I/O interface 1016 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ410) port, an RJ10 port, a proprietary port, combinations thereof, or the like. In some embodiments, the mobile device 1000 can be configured to synchronize with another device to transfer content to and/or from the mobile device 1000. In some embodiments, the mobile device 1000 can be configured to receive updates to one or more of the applications 1010 via the I/O interface 1016, though this is not necessarily the case. In some embodiments, the I/O interface 1016 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 1016 may be used for communications between the mobile device 1000 and a network device or local device.

The mobile device 1000 also can include a communications component 1018. The communications component 1018 can be configured to interface with the processor 1004 to facilitate wired and/or wireless communications with one or more networks, such as the network 122. In some embodiments, the communications component 1018 includes a multimode communications subsystem for facilitating communications via the cellular network and one or more other networks.

The communications component 1018, in some embodiments, includes one or more transceivers. The one or more transceivers, if included, can be configured to communicate over the same and/or different wireless technology standards with respect to one another. For example, in some embodiments one or more of the transceivers of the communications component 1018 may be configured to communicate using GSM, CDMAONE, CDMA2000, LTE, and various other 2G, 2.5G, 3G, 4G, and greater generation technology standards. Moreover, the communications component 1018 may facilitate communications over various channel access methods (which may or may not be used by the aforementioned standards) including, but not limited to, TDMA, FDMA, W-CDMA, OFDM, SDMA, and the like.

In addition, the communications component 1018 may facilitate data communications using GPRS, EDGE, the HSPA protocol family including HSDPA, EUL or otherwise termed HSUPA, HSPA+, and various other current and future wireless data access standards. In the illustrated embodiment, the communications component 1018 can include a first transceiver (“TxRx”) 1020A that can operate in a first communications mode (e.g., GSM). The communications component 1018 also can include an N^{th} transceiver (“TxRx”) 1020N that can operate in a second communications mode relative to the first transceiver 1020A (e.g., UMTS). While two transceivers 1020A-N (hereinafter collectively and/or generically referred to as “transceivers 1020”) are shown in FIG. 10, it should be appreciated that less than two, two, or more than two transceivers 1020 can be included in the communications component 1018.

The communications component 1018 also can include an alternative transceiver (“Alt TxRx”) 1022 (e.g., the NFC component 708) for supporting other types and/or standards of communications. According to various contemplated embodiments, the alternative transceiver 1022 can communicate using various communications technologies such as, for example, WI-FI, WIMAX, BLUETOOTH, BLE, infrared, infrared data association (“IRDA”), NFC, other RF technologies, combinations thereof, and the like.

In some embodiments, the communications component 1018 also can facilitate reception from terrestrial radio networks, digital satellite radio networks, internet-based radio service networks, combinations thereof, and the like. The communications component 1018 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 1000 also can include one or more sensors 1024. The sensors 1024 can include accelerometers, magnetometers, gyroscopes, infrared sensors, noise sensors, microphones, temperature sensors, light sensors, air quality sensors, movement sensors, orientation sensors, noise sensors, proximity sensors, any of the other sensors described herein, combinations thereof, and the like. One or more of the sensors 1024 can be used to detect movement of the mobile device 1000. Additionally, audio capabilities for the mobile device 1000 may be provided by an audio I/O component 1026. The audio I/O component 1026 of the mobile device 1000 can include one or more speakers for the output of audio signals, one or more microphones for the collection and/or input of audio signals, and/or other audio input and/or output devices.

The illustrated mobile device 1000 also can include a subscriber identity module (“SIM”) system 1028. The SIM system 1028 can include a universal SIM (“USIM”), a universal integrated circuit card (“UICC”) and/or other identity devices. The SIM system 1028 can include and/or can be connected to or inserted into an interface such as a slot interface 1030. In some embodiments, the slot interface 1030 can be configured to accept insertion of other identity cards or modules for accessing various types of networks. Additionally, or alternatively, the slot interface 1030 can be configured to accept multiple subscriber identity cards. Because other devices and/or modules for identifying users and/or the mobile device 1000 are contemplated, it should be understood that these embodiments are illustrative, and should not be construed as being limiting in any way.

The mobile device 1000 also can include an image capture and processing system 1032 (“image system”). The image system 1032 can be configured to capture or otherwise obtain photos, videos, and/or other visual information. As such, the image system 1032 can include cameras, lenses, charge-coupled devices (“CCDs”), combinations thereof, or the like. The mobile device 1000 may also include a video system 1034. The video system 1034 can be configured to capture, process, record, modify, and/or store video content. Photos and videos obtained using the image system 1032 and the video system 1034, respectively, may be added as message content to an MMS message, email message, and sent to another mobile device. The video and/or photo content also can be shared with other devices via various types of data transfers via wired and/or wireless communication devices as described herein.

The mobile device 1000 also can include one or more location components 1036 (e.g., the location component 712). The location components 1036 can be configured to send and/or receive signals to determine a location of the mobile device 1000. According to various embodiments, the location components 1036 can send and/or receive signals from GPS devices, assisted-GPS (“A-GPS”) devices, WI-FI/WIMAX and/or cellular network triangulation data, combinations thereof, and the like. The location component 1036 also can be configured to communicate with the communications component 1018 to retrieve triangulation data for determining a location of the mobile device 1000. In some embodiments, the location component 1036 can interface with cellular network nodes, telephone lines, satellites, location transmitters and/or beacons, wireless network transmitters and receivers, combinations thereof, and the like. In some embodiments, the location component 1036 can include and/or can communicate with one or more of the sensors 1024 such as a compass, an accelerometer, and/or a gyroscope to determine the orientation of the mobile device 1000. Using the location component 1036, the mobile device 1000 can generate and/or receive data to identify its geographic location, or to transmit data used by other devices to determine the location of the mobile device 1000. The location component 1036 may include multiple components for determining the location and/or orientation of the mobile device 1000.

The illustrated mobile device 1000 also can include a power source 1036. The power source 1036 can include one or more batteries, power supplies, power cells, and/or other power subsystems including alternating current (“AC”) and/or direct current (“DC”) power devices. The power source 1036 also can interface with an external power system or charging equipment via a power I/O component 1040. Because the mobile device 1000 can include additional and/or alternative components, the above embodiment should be understood as being illustrative of one possible operating environment for various embodiments of the concepts and technologies described herein. The described embodiment of the mobile device 1000 is illustrative, and should not be construed as being limiting in any way.

FIG. 11 is a block diagram illustrating a computer system 1100 configured to provide the functionality described herein in accordance with various embodiments of the concepts and technologies disclosed herein. In some embodiments, the compute resources 116, the storage resources 118, and/or the other resources 120 utilize hardware architecture similar or identical to the computer system 1100 described herein with respect to FIG. 11. It should be understood, however, that the compute resources 116, the storage resources 118, and/or the other resources 120 may or may not utilize hardware that includes the functionality described herein with reference to FIG. 11.

The computer system 1100 includes a processing unit 1102, a memory 1104, one or more user interface devices 1106, one or more input/output (“I/O”) devices 11011, and one or more network devices 1110, each of which is operatively connected to a system bus 1112. The bus 1112 enables bi-directional communication between the processing unit 1102, the memory 1104, the user interface devices 1106, the I/O devices 11011, and the network devices 1110.

The processing unit 1102 may be a standard central processor that performs arithmetic and logical operations, a more specific purpose programmable logic controller (“PLC”), a programmable gate array, or other type of processor known to those skilled in the art and suitable for controlling the operation of the computer system 1100. Processing units are generally known, and therefore are not described in further detail herein.

The memory 1104 communicates with the processing unit 1102 via the system bus 1112. In some embodiments, the memory 1104 is operatively connected to a memory controller (not shown) that enables communication with the processing unit 1102 via the system bus 1112. The memory 1104 includes an operating system 1114 such as the operating system 1112, and one or more program modules 1116 such the data module 302, the action determination module 304, the learning module 306, the controller data module 502, the controller action determination module 504, the controller learning module 506, and/or other modules and software components described herein. The operating system 1114 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 1116 may include various software and/or program modules described herein. The program modules 1116 can be embodied in computer-readable media containing instructions that, when executed by the processing unit 1102, perform at least a portion of one or more of the methods described above. According to embodiments, the program modules 1116 may be embodied in hardware, software, firmware, or any combination thereof.

By way of example, and not limitation, computer-readable media may include any available computer storage media or communication media that can be accessed by the computer system 1100. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 1100. In the claims, the phrase “computer storage medium” and variations thereof does not include waves or signals per se and/or communication media.

The user interface devices 1106 may include one or more devices with which a user accesses the computer system 1100. The user interface devices 1106 may include, but are not limited to, computers, servers, personal digital assistants, cellular phones, or any suitable computing devices. The I/O devices 1108 enable a user to interface with the program modules 1116. In one embodiment, the I/O devices 1108 are operatively connected to an I/O controller (not shown) that enables communication with the processing unit 1102 via the system bus 1112. The I/O devices 1108 may include one or more input devices, such as, but not limited to, a keyboard, a mouse, or an electronic stylus. Further, the I/O devices 1108 may include one or more output devices, such as, but not limited to, a display screen or a printer to output data in the form of text, numbers, characters, maps, other visualizations, and the like.

The network devices 1110 enable the computer system 1100 to communicate with other networks or remote systems via one or more networks such as the network 122. Examples of the network devices 1110 include, but are not limited to, a modem, a radio frequency (“RF”) or infrared (“IR”) transceiver, a telephonic interface, a bridge, a router, or a network card. The network 114 may include a wireless network such as, but not limited to, a WLAN such as a WI-FI network, a WWAN, a Wireless Personal Area Network (“WPAN”) such as BLUETOOTH, a WMAN such a WiMAX network, or a cellular network. Alternatively, the network 114 may be a wired network such as, but not limited to, a WAN such as the Internet, a LAN, a wired PAN, or a wired MAN.

Turning now to FIG. 12, additional details of an embodiment of the network 122 are illustrated, according to an illustrative embodiment. The network 122 can include a cellular network 1202, a packet data network 1204, for example, the Internet, and a circuit switched network 1206, for example, a publicly switched telephone network (“PSTN”). The cellular network 1202 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 1202 also includes radios and nodes for receiving and transmitting voice, data, and combinations thereof to and from radio transceivers, networks, the packet data network 1204, and the circuit switched network 1206.

A mobile communications device 1208, such as, for example, the mobile devices 222, 704, 804A, 804B, and 916, a cellular telephone, a user equipment, a mobile terminal, a PDA, a laptop computer, a handheld computer, and combinations thereof, can be operatively connected to the cellular network 1202. The cellular network 1202 can be configured as a 2G GSM network and can provide data communications via GPRS and/or EDGE. Additionally, or alternatively, the cellular network 1202 can be configured as a 3G UMTS network and can provide data communications via the HSPA protocol family, for example, HSDPA, EUL (also referred to as HSUPA), and HSPA+. The cellular network 1202 also is compatible with 4G mobile communications standards as well as evolved and future mobile standards.

The packet data network 1204 includes various devices, for example, servers, computers, databases, and other devices in communication with another, as is generally known. The packet data network 1204 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 1204 includes or is in communication with the Internet. The circuit switched network 1206 includes various hardware and software for providing circuit switched communications. The circuit switched network 1206 may include, or may be, what is often referred to as a plain old telephone system (“POTS”). The functionality of a circuit switched network 1206 or other circuit-switched network are generally known and will not be described herein in detail.

The illustrated cellular network 1202 is shown in communication with the packet data network 1204 and a circuit switched network 1206, though it should be appreciated that this is not necessarily the case. One or more Internet-capable devices 1210, for example, the user computer 904, a personal computer (“PC”), a laptop, a portable device, or another suitable device, can communicate with one or more cellular networks 1202, and devices connected thereto, through the packet data network 1204. It also should be appreciated that the Internet-capable device 1210 can communicate with the packet data network 1204 through the circuit switched network 1206, the cellular network 1202, and/or via other networks (not illustrated).

As illustrated, a communications device 1212, for example, the user device 110, a telephone, facsimile machine, modem, computer, or the like, can be in communication with the circuit switched network 1206, and therethrough to the packet data network 1204 and/or the cellular network 1202. It should be appreciated that the communications device 1212 can be an Internet-capable device, and can be substantially similar to the Internet-capable device 1210. In the specification, the network 114 may be used to refer broadly to any combination of the networks 1202, 1204, 1206. It should be appreciated that substantially all of the functionality described with reference to the network 114 can be performed by the cellular network 1202, the packet data network 1204, and/or the circuit switched network 1206, alone or in combination with other networks, network elements, and the like.

Based on the foregoing, it should be appreciated that aspects of a personal security agent have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

What is claimed is:

1. A computing system comprising:
a processor; and
a memory storing computer-executable instructions that, when executed by the processor, cause the processor to perform operations comprising
receiving data from a data source,
receiving a job request to provide security for an entity, the job request comprising a job requirement,
analyzing the job requirement and the data to determine an action, and
providing instructions for executing the action to a controller domain that executes the action in at least partial fulfillment of the job requirement.

2. The computing system of claim 1, wherein the operations further comprise receiving an effect of the action from the controller domain.

3. The computing system of claim 2, wherein the operations further comprise executing a learning algorithm to utilize the effect to improve security for the entity.

4. The computing system of claim 3, wherein the operations further comprise receiving a learning input, and wherein executing the learning algorithm further comprises executing the learning algorithm to utilize the learning input to improve security for the entity.

5. The computing system of claim 1, wherein the operations further comprise:
receiving a query from the controller domain, the query being in regards to performance of the action; and
responding to the query with information for use by the controller domain in executing the action in at least partial fulfillment of the job requirement.

6. The computing system of claim 1, wherein the entity comprises a user, and wherein the controller domain comprises a personal security controller that can execute the action if the action pertains to a personal domain of the user.

7. The computing system of claim 6, wherein the controller domain further comprises a work security controller that can execute the action if the action pertains to a work domain of the user.

8. The computing system of claim 1, wherein the action comprises a verification of a mobile payment request, a verification of maliciousness of a message, or an authentication for virtual private network access.

9. A method comprising:
receiving, by a compute resource comprising a processor that executes a personal security agent, data from a data source;
receiving, by the compute resource, a job request to provide security for an entity, the job request comprising a job requirement;
analyzing, by the compute resource, the job requirement and the data to determine an action; and
providing, by the compute resource, instructions for executing the action to a controller domain that executes the action in at least partial fulfillment of the job requirement.

10. The method of claim 9, further comprising receiving, by the compute resource, an effect of the action from the controller domain.

11. The method of claim 10, further comprising executing, by the compute resource, a learning algorithm to utilize the effect to improve security for the entity.

12. The method of claim 11, further comprising receiving, by the compute resource, a learning input, and wherein executing the learning algorithm further comprises executing, by the compute resource, the learning algorithm to utilize the learning input to improve security for the entity.

13. The method of claim 9, further comprising:
receiving, by the compute resource, a query from the controller domain, the query being in regards to performance of the action; and
responding, by the compute resource, to the query with information for use by the controller domain in executing the action in at least partial fulfillment of the job requirement.

14. The method of claim 9, wherein the entity comprises a user, and wherein the controller domain comprises a personal security controller that can execute the action if the action pertains to a personal domain of the user.

15. The method of claim 14, wherein the controller domain further comprises a work security controller that can execute the action if the action pertains to a work domain of the user.

16. The method of claim 9, wherein the action comprises a verification of a mobile payment request, a verification of maliciousness of a message, or an authentication for virtual private network access.

17. A computer storage medium having computer-executable instructions stored thereon that, when executed by a processor of a user device, cause the user device to perform operations comprising:
receiving data from a data source;
receiving a job request to provide security for an entity, the job request comprising a job requirement;
analyzing the job requirement and the data to determine an action; and
providing instructions for executing the action to a controller domain that executes the action in at least partial fulfillment of the job requirement.

18. The computer storage medium of claim 17, wherein the operations further comprise:
receiving an effect of the action from the controller domain;
receiving a learning input; and
executing a learning algorithm to utilize the effect and the learning input to improve security for the entity.

19. The computer storage medium of claim 17, wherein the operations further comprise:
receiving a query from the controller domain, the query being in regards to performance of the action; and
responding to the query with information for use by the controller domain in executing the action in at least partial fulfillment of the job requirement.

20. The computer storage medium of claim 17, wherein the action comprises a verification of a mobile payment request, a verification of maliciousness of a message, or an authentication for virtual private network access.
